(19) United States
(12) Patent Application Publication
(10) Pub. No.: US 2010/0118640 A1
(43) Pub. Date: May 13, 2010

(54) MOBILE CONCRETE MIXING PLANT

(75) Inventors: Reinhard Matye, Charlevoix, MI (US); Antero Tarvudd, Petoskey, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: DCL, Inc., Charlevoix, MI (US)

(21) Appl. No.: 12/434,342

(22) Filed: May 1, 2009

Related U.S. Application Data
(60) Provisional application No. 61/049,951, filed on May 2, 2008.

(51) Int. Cl. B28C 7/04

(52) U.S. Cl. 366/6; 366/41

(57) ABSTRACT

A transportable concrete mixing plant is provided and includes a frame, a mixing drum for mixing concrete, a rail positioned above the mixing drum, and a carriage assembly mounted to the rail for positioning containers of dry premix concrete so that the premix may be dispensed from the containers into the drum. The concrete pump dispenses liquid concrete from the mixing drum and pumps it to a remote location, such as a work site.

### CROSS REFERENCE TO RELATED APPLICATION

The present application claims the benefit of U.S. provisional application Ser. No. 61/049,951, filed May 2, 2008, which is hereby incorporated herein by reference in its entirety.

### FIELD OF THE INVENTION

The present invention relates to concrete mixing plants and, more particularly, to transportable concrete mixing plants.

### BACKGROUND OF THE INVENTION

Mobile concrete mixing plants are typically sized to fit on a roadable trailer, or are made up of assembled components that can be disassembled from one another and individually transported by road, such as on a semi-trailer. Typically, mobile concrete mixing plants are temporarily set up in a location near an immediate need for wet concrete, such as alongside a new road or a building project. The mobile mixing plant is supplied with concrete ingredients, such as cement, sand, aggregate, and water, which are mixed together in desired proportions and dispensed as flowable concrete.

### SUMMARY OF THE INVENTION

The present invention provides a substantially self-contained transportable concrete mixing plant mounted on a roadable trailer. The transportable mixing plant may be positioned on a non-level support surface and leveled to compensate for the support surface. The transportable mixing plant receives dry concrete premix, mixes the premix with water to form liquid or flowable concrete, and pumps the liquid concrete to a location that is remote from the mixing plant.

According to one form of the present invention, a transportable concrete mixing apparatus is provided for supplying liquid concrete in a substantially continuous manner. The apparatus includes a transport frame, a base frame, a mixing drum, an overhead rail, a carriage assembly, and a concrete pump. The base frame is mounted to the transport frame, and the mixing drum is supported at the base frame. The overhead rail is positioned above the mixing drum and supports the carriage assembly above the drum. The carriage assembly translates along the overhead rail and supports a container of dry premix concrete, which may be positioned above the mixing drum and opened to dispense premixed concrete into the drum. The concrete pump pumps liquid concrete received from the drum to a location that is remote from the apparatus.

In one aspect, the base frame is pivotally supported at the transport frame, and an actuator is provided for pivoting the base frame relative to the transport frame, thereby permitting the transport frame to be positioned at a non-level location and adjusting the base frame to a level orientation with the actuator.

In another aspect, a winch is provided at the carriage assembly for raising and lowering the container of premix concrete. The winch may be, for example, an electric winch.

In yet another aspect, a pair of mixing drums is pivotally mounted to the base frame. Each of the mixing drums may be independently pivoted between a mixing orientation and a dispensing orientation.

In still another aspect, a water tank is provided at the base frame for supplying water to the mixing drum to facilitate the preparation of liquid concrete from the premix concrete.

In a further aspect, a hydraulic motor is provided for rotating the mixing drum about a longitudinal axis. Optionally, the hydraulic motor is driven by a hydraulic pump that is powered by an electric motor, which in turn is powered by an electrical generator onboard the mixing apparatus.

In a still further aspect, a control is provided for controlling the mixing drum, the actuator, the concrete pump, the electrical generator, the electric motor, a winch, or any combination thereof.

According to another form of the present invention, a method is provided for preparing pourable concrete. The method includes raising and positioning a container of premix concrete above a mixing drum with a carriage assembly. Premix concrete is dispensed from the container into the mixing drum where it is mixed with water. The mixed concrete is then dispensed into a concrete pump, from which it is pumped to a remote location.

In one aspect, two mixing drums are provided for mixing concrete. A first mixing drum is operable independently from a second mixing drum so that the first mixing drum can receive and mix premix concrete and water while the second drum dispenses mixed concrete into the concrete pump. The second drum then receives and mixes premix concrete and water while the first drum dispenses mixed concrete into the concrete pump.

Therefore, the transportable concrete mixing plant of the present invention provides a transportable and substantially self-contained concrete mixing plant that is capable of supplying a substantially constant supply of liquid concrete. Further, the transportable mixing plant of the present invention may be positioned on uneven ground and may pump liquid concrete to remote locations, thereby obviating the need for concrete-carrying vehicles.

These and other objects, advantages, purposes, and features of the present invention will become apparent upon review of the following specification in conjunction with the drawings.

### BRIEF DESCRIPTION OF THE DRAWINGS

FIG. 1 is a side elevation of a transportable concrete mixing plant in accordance with the present invention and supported upon a level surface;

FIG. 2 is a side elevation of the plant of FIG. 1, positioned on a sloped support surface; and

FIG. 3 is a top plan of the transportable concrete mixing plant of FIG. 1.

### DESCRIPTION OF THE PREFERRED EMBODIMENTS

Referring now to the drawings and the illustrative embodiments depicted therein, a transportable concrete mixing plant 10 includes a base frame 12, a wheeled transport frame or trailer frame 14, and a superstructure frame assembly 16. Transportable concrete mixing plant 10 provides a substantially self-contained concrete mixing and dispensing facility that is readily transported, such as by road, to a location near a worksite. Plant 10 is operable to supply a substantially constant flow of liquid concrete to a location spaced from the plant.

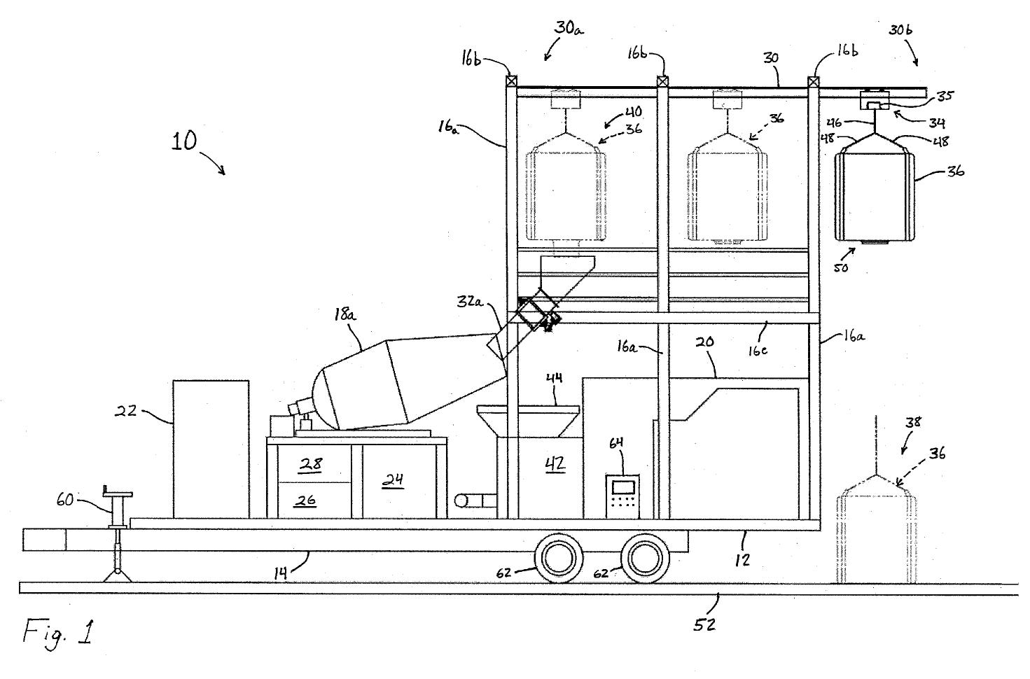

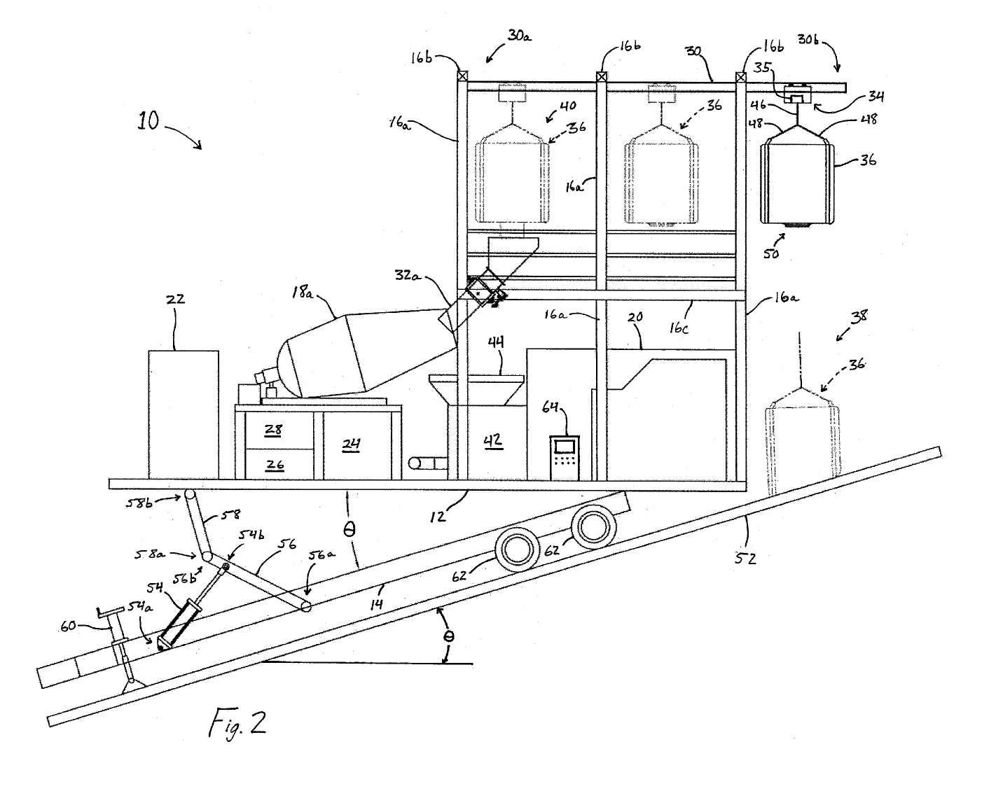

Base frame 12 supports a pair of mixing drums 18a, 18b, a concrete pump 20, an electrical generator 22, a hydraulic power unit 24, a water tank 26, and a fuel tank 28. Superstructure frame assembly 16, which is mounted to base frame 12 and extends upwardly therefrom, includes a plurality of vertical members 16a, horizontal cross-members 16b, and horizontal longitudinal members 16c. Superstructure frame assembly 16 supports an overhead rail 30 at horizontal cross-members 16b and further supports a pair of supply chutes 32a, 32b (FIGS. 1 and 2). A carriage assembly 34 is movably mounted to overhead rail 30 for moving containers 36 of premix concrete from a loading location 38 to a discharge location 40, as will be described in greater detail below.

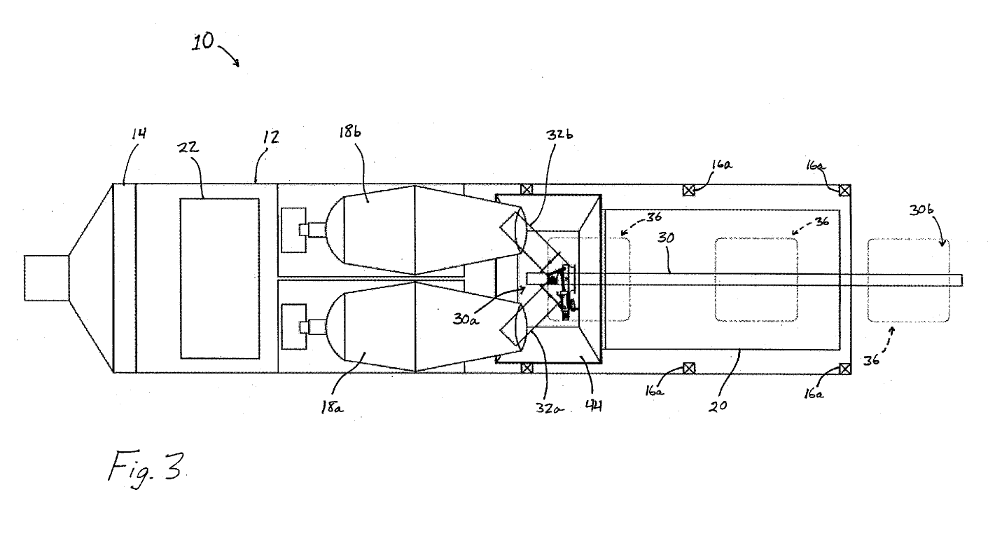

Mixing drums 18a, 18b are positioned adjacent one another above base frame 12, and are independently vertically pivotable (about a horizontal axis) between a loading/mixing position with their open ends directed upwardly and the dispensing position with their open ends lowered from the loading/mixing position (loading/mixing position shown). As best seen in FIG. 3, mixing drum 18a is fed with dry premix concrete via supply chute 32a, and mixing drum 18b is supplied by supply chute 32b. At their respective loading/mixing positions, mixing drums 18a, 18b are rotatably driven about their respective longitudinal axes to mix dry premix concrete, received from respective chutes 32a, 32b, with water supplied from water tank 26 until the mixture is thoroughly wetted and pourable or flowable. A metered quantity of water is pumped from water tank 26 into each drum through each drum's respective open end using a water pump. After the premix and water are suitably mixed, the mixing drum is pivoted downwardly to the dispensing position, whereupon continued rotation of the drum urges the flowable or liquid concrete into a receiving hopper 42 via a funnel 44. Optionally, supply chutes 32a, 32b may include replaceable wear plates to prevent excessive wear of the chutes.

In operation, mixing drums 18a, 18b are independently controlled so that while mixing drum 18a is tilted upwardly for receiving premix and mixing the premix with water, mixing drum 18b is tilted downwardly for dispensing liquid concrete into receiving hopper 42. Optionally, the time required for receiving dried premix concrete and thoroughly mixing it with water may be approximately equal to the time required to dispense the liquid concrete contents of the mixing drum into receiving hopper 42, thereby permitting substantially continuous flow of liquid concrete into hopper 42 by alternately mixing and dispensing from mixing drum 18a and mixing drum 18b.

Thus, mixing drums 18a, 18b may be alternately sequenced so that mixing drum 18a is receiving or mixing dry premix from supply chute 32a while mixing drum 18b is dispensing liquid concrete into receiving hopper 42. When mixing drum 18a has thoroughly mixed its contents with water to form liquid concrete, mixing drum 18a is tilted downwardly to dispense liquid concrete into receiving hopper 42 while mixing drum 18b is tilted upwardly to receive its next load of dry premix. Each mixing drum 18a, 18b may be generally conventional in design, having helical mixing paddles or blades along an inner surface of each drum, whereby rotation in one direction draws concrete to the closed end of the drum for mixing, and rotation in the opposite direction directs mixed concrete toward the open end of the drum. Mixing drums 18a, 18b may be one cubic yard capacity cement mixers, for example, and rotatably and pivotally driven by actuators powered by hydraulic power unit 24. Hydraulic power unit 24 may be a self-contained thirty horsepower unit driven by an electric motor powered by the generator 22, for example, or other suitable power unit.

Overhead rail 30 is supported centrally above base frame 12 by superstructure frame assembly 16 and permits the loading and positioning of containers 36 for dispensing dry premix concrete into one of mixing drums 18a, 18b via supply chutes 32a, 32b. Rail 30 has a front end portion 30a positioned generally above supply chutes 32a, 32b and a rear end portion 30b opposite front end portion 30a. Preferably, overhead rail 30 is a monorail, such as an I-beam or a C-shaped beam that supports carriage assembly 34 and permits carriage assembly 34 to translate longitudinally along mixing plant 10. Rear end portion 30b of overhead rail 30 may extend rearwardly beyond a rearward extent of base frame 12 to facilitate the loading of containers 36, as will be described in greater detail.

Carriage assembly 34 may be equipped with a manual or powered winch 35, such as an electric winch, having a cable 46 that engages lift straps 48 of container 36. Thus, carriage assembly 34 is operable to raise and lower cable 46 in order to raise and lower container 36. Winch 35 may be a 7.5 horsepower electric winch capable of raising and lowering cable 46 at about twenty-two feet-per-minute, for example, or any other suitable powered winch.

Containers 36 may be made of woven fabric such as polypropylene fabric or the like, having square dimensions of 35 inches square by 51 inches high in order to hold at least about one cubic yard of dry premix concrete. Lift straps 48 are sewn to the four corners of containers 36 and may incorporate loops to facilitate attachment of cable 46 thereto. Containers 36 include a closable bottom opening 50 that is normally held closed by a draw string or other closure device. The draw string is normally released when container 36 is positioned above supply chutes 32a, 32b to release dry premix concrete into one of mixing drums 18a, 18b.

Concrete pump 20 is supplied with liquid concrete from mixing drums 18a, 18b via receiving hopper 42 and is operable to pump the liquid concrete to a nearby location, such as a transport vehicle, or to a distant location, such as a worksite. For example, concrete pump 20 may be powered by a 100 horsepower diesel engine and capable of pumping approximately sixty cubic yards of liquid concrete per hour a horizontal distance of up to about 900 feet and a vertical distance of up to about 290 feet through a pipe (not shown) having a diameter of about five inches.

Electrical generator 22 provides electricity for operation of the entire transportable concrete mixing plant 10, such as for operating an electric motor to drive hydraulic power unit 24, to drive the electric winch 35 and carriage assembly 34, to power electric lights for night operation, and to power an optional control panel 64 for controlling the operation of mixing plant 10. For example, electrical generator 22 may be powered by a diesel engine to produce approximately 80 kilowatts of electricity.

Water tank 26 supplies water to mixing drums 18a, 18b for mixing with dry premix concrete and producing liquid concrete therefrom. For example, water tank 26 may have a capacity of approximately 500 gallons, which is sufficient for mixing approximately 16 cubic yards of premix. A pump is provided for pumping water into mixing drums 18a, 18b. Fuel tank 28 supplies fuel, such as diesel fuel, to electrical generator 22, concrete pump 20, and any other internal combustion engine or fueled device located at mixing plant 10.

As best shown in FIG. 2, base frame 12 is pivotally supported at a rear end of trailer frame 14 so that trailer frame 14 may be parked or positioned at an inclined support surface 52 while maintaining base frame 12 in a level or horizontal orientation. The orientation of base frame 12 is adjustable via an actuator 54 connected between trailer frame 14 and base frame 12. For example, actuator 54 may be a double-acting hydraulic cylinder having a first end 54a pivotally mounted at trailer frame 14, and a second end 54b pivotally mounted at a first link 56. First link 56 is pivotally connected at a first end 56a to a location on trailer frame 14 spaced from first end 54a of actuator 54 and is pivotally mounted at a second end 56b to a first end 58a of a second link 58. Second link 58 has a second end 58b pivotally connected to base frame 12. Optionally, the various components of mixing plant may be mounted to an articulating skid, such as a steel plate, that pivots relative to the base frame and/or the trailer frame.

Thus, by extension and retraction of actuator 54, a front end 12a of base frame 12 is urged upwardly until base frame 12 is substantially level. Referring to FIG. 2, an angle θ is thereby formed between base frame 12 and trailer frame 14. Angle θ may range anywhere from zero degrees to thirty degrees or more, thus enabling mixing plant 10 to be positioned on a substantially sloped support surface 52 without affecting the operation of mixing plant 10.

As best seen in FIGS. 1 and 2, trailer frame 14 may be equipped with one or more jack stands or outriggers 60 that are laterally and vertically extendable to support trailer frame 14 opposite one or more wheels 62 at the rear end of trailer frame 14. Trailer frame 14 may be part of a conventional pup-style trailer and include a steel frame and wood deck, for example. Alternatively, or additionally, mixing plant 10 may be supported by a rail car, a floating barge, or other vehicle or support.

Accordingly, transportable concrete mixing plant 10 provides a substantially self-contained concrete mixing and dispensing facility that is readily transported to a convenient location and is operable to supply a substantially constant flow of liquid concrete to a location spaced from mixing plant 10. Transportable concrete mixing plant 10 is first moved, typically via road, such as by connecting trailer frame 14 to a tow vehicle such as a semi-tractor. Mixing plant 10 is positioned on support surface 52 and supported in place by outriggers 60 and wheels 62, after which the tow vehicle may be detached. If support surface 52 is sloped at angle θ, mixing plant 10 is typically oriented with its rear end and loading location 38 positioned at the higher elevation. In this manner, actuator 54 may be extended to pivot base frame 12 counterclockwise as viewed in FIG. 2, relative to trailer frame 14, at angle θ so that base frame 12 is supported in a substantially level, horizontal orientation. Optionally, the base frame may be hinged to the trailer frame at their front ends so that the mixing plant may be oriented with its front end positioned at the higher elevation.

Containers 36 are positioned at loading location 38 behind base frame 12 and below a rear end portion 30b of overhead rail 30. Cable 46 is lowered from carriage assembly 34 and attached to lift straps 48 of container 36, after which cable 46 is drawn upwardly into carriage assembly 34, such as with winch 35, until bottom opening 50 of container 36 is raised above the level of supply chutes 32a, 32b. Carriage assembly 34 is then urged forwardly, either manually or with a powered actuator (such as a conventional electric trolley drive unit), along overhead rail 30 until it reaches a front portion 30a of rail 30 so that bottom opening 50 is positioned directly above supply chutes 32a, 32b. Bottom opening 50 is then opened to release dry premix concrete from container 36 into one or both of supply chutes 32a, 3.2b. Dry premix concrete flows through bottom opening 50 of container 36 and slides or flows down into one of mixing drums 18a, 18b via corresponding supply chute 32a, 32b. Once empty, container 36 is removed from carriage assembly 34, which is urged backward along overhead rail 30 toward rear portion 30b in order to receive the next container. Containers 36 may be discarded or reused once they have been emptied.

Mixing drum 18a or 18b receives water from water tank 26 and proceeds to rotate about its longitudinal axis until the water and premix are sufficiently mixed to form flowable or liquid concrete, after which the mixing drum is tilted or pivoted downwardly to dispense the liquid concrete into funnel 44, which channels the liquid concrete into receiving hopper 42. Once the mixing drum is emptied, it is pivoted upwardly to receive the next batch of dry premix concrete and water.

Liquid concrete in receiving hopper 42 is directed into concrete pump 20, which pumps the liquid concrete away from mixing plant 10 and into a waiting transport vehicle or to the point of use. By providing a steady supply of containers 36 containing dry premix concrete, fuel, and water, concrete mixing pump 10 may be operated substantially constantly to provide a substantially constant flow of pourable liquid concrete at a work site.

Optionally, control panel 64 may be provided at mixing plant 10 for controlling various operations such as, for example, positioning outriggers 60, extending and retracting actuator 54, extending and retracting cable 46, moving carriage assembly 34 along overhead rail 30, controlling the tilt and rotation of mixing drums 18a, 18b, controlling concrete pump 20, controlling the water pump, controlling the electrical generator 22, and controlling lights for operations in darkness. Control panel 64 includes a controller, such as a microprocessor board controller, which is in communication with the various components on the mixing plant. Optionally, the controller permits automated operation of mixing plant 10. It will be understood that plant 10 may be controlled by an operator via control panel 64, or may be fully manually operated, without departing from the spirit and scope of the present invention.

Changes and modifications in these specifically described embodiments may be carried out without departing from the principles of the present invention, which is intended to be limited only by the scope of the appended claims, as interpreted according to the principles of patent law including the doctrine of equivalents.

1. A transportable concrete mixing apparatus comprising:
a transport frame;
a base frame at said transport frame;
a mixing drum supported at said base frame;
an overhead rail above said mixing drum;
a carriage assembly movably supported at said overhead rail and adapted to support a container of premix concrete; and
a concrete pump adapted to pump concrete to a location spaced from said apparatus;
wherein the container of premix concrete is supportable above said mixing drum by said carriage assembly for dispensing the premix concrete into said mixing drum, and wherein said mixing drum is operable to dispense mixed concrete into said concrete pump.

2. The transportable concrete mixing apparatus according to claim 1, wherein said base frame is pivotally supported at said transport frame.

3. The transportable concrete mixing apparatus according to claim 2, further comprising an actuator adapted to pivot said base frame with respect to said transport frame.

4. The apparatus according to claim 3, wherein said actuator is adapted to pivot said base frame to a level orientation when said transport frame is oriented at a non-level orientation.

5. The apparatus according to claim 1, further comprising a winch at said carriage assembly, said winch adapted to raise and lower the container of premix concrete.

6. The apparatus according to claim 1, wherein said mixing drum comprises a pair of pivotally mounted mixing drums, wherein each of said mixing drums is pivotable between a mixing orientation and a dispensing orientation.

7. The apparatus according to claim 6, wherein said mixing drums alternately mix concrete and dispense mixed concrete into said concrete pump.

8. The apparatus according to claim 1, further comprising a water tank adapted to supply water to said mixing drum for wetting the premix concrete and forming the mixed concrete.

9. The apparatus according to claim 1, further comprising a hydraulic motor adapted to rotate said mixing drum about a longitudinal axis.

10. The apparatus according to claim 9, further comprising:
a hydraulic pump adapted to drive said hydraulic motor;
an electric motor adapted to drive said hydraulic pump; and
an electrical generator for generating electricity to energize said electric motor.

11. The apparatus according to claim 1, wherein said overhead rail comprises a monorail.

12. The apparatus according to claim 1, comprising:
an actuator adapted to pivot said base frame with respect to said transport frame;
a hydraulic motor adapted to rotate said mixing drum about a longitudinal axis;
a hydraulic pump adapted to drive said hydraulic motor;
an electric motor adapted to drive said hydraulic pump;
an electrical generator adapted to generate electricity to energize said electric motor; and
a winch at said carriage assembly, said winch adapted to raise and lower the container of premix concrete.

13. The apparatus according to claim 12, further comprising a control adapted to control at least one of said mixing drum, said actuator, said concrete pump, said electrical generator, said electric motor, and said winch.

14. The apparatus according to claim 1, wherein said transport frame comprises a wheeled trailer frame adapted to be conveyed along a road surface.

15. A transportable concrete mixing apparatus comprising:
a transport frame;
a base frame pivotally supported at said transport frame;
an actuator adapted to pivot said base frame with respect to said transport frame;
a mixing drum supported at said base frame;
an overhead rail above said mixing drum;
a carriage assembly movably supported at said overhead rail and adapted to support a container of premix concrete;
a winch at said carriage assembly, said winch adapted to raise and lower the container of premix concrete;
a water tank supported at said base frame and adapted to supply water to said mixing drum for wetting the premix concrete;
a concrete pump adapted to pump concrete to a location spaced from said apparatus; and
wherein the container of premix concrete is supportable above said mixing drum by said carriage assembly for dispensing the premix concrete into said mixing drum, and wherein said mixing drum is operable to dispense mixed concrete into said concrete pump.

16. A method of preparing pourable concrete, said method comprising:
providing a base frame supported at a transport frame, a mixing drum supported at the base frame, an overhead rail above the mixing drum, a carriage assembly movably supported at the overhead rail, and a concrete pump;
providing a container of premix concrete;
raising the container of premix concrete above the level of the mixing drum with the carriage assembly;
positioning the container of premix concrete above the mixing drum;
dispensing premix concrete from the container into the mixing drum;
mixing the premix concrete with water in the mixing drum;
dispensing mixed concrete from the mixing drum into the concrete pump; and
pumping the mixed concrete to a remote location with the concrete pump.

17. The method of claim 16, wherein said providing the mixing drum comprises providing a first mixing drum and a second mixing drum, wherein said dispensing premix concrete from the container into the mixing drum comprises dispensing premix concrete from a first container into the first mixing drum and then dispensing premix concrete from a second container into the second mixing drum.

18. The method of claim 17, wherein said mixing premix concrete with water in the mixing drum comprises mixing premix concrete with water in the first mixing drum and then mixing premix concrete with water in the second mixing drum.

19. The method of claim 17, wherein said dispensing mixed concrete from the mixing drum into the concrete pump comprises dispensing the mixed concrete from the first mixing drum into the concrete pump while the second mixing drum mixes premix concrete with water, and dispensing the mixed concrete from the second mixing drum into the concrete pump while the first mixing drum mixes premix concrete with water.

20. The method of claim 16, wherein the base frame is pivotally mounted at the transport frame and wherein an actuator is provided between the base frame and the transport frame, said method further comprising:
positioning the transport frame at a sloped support surface; and
leveling the base frame by pivoting the base frame relative to the transport frame with the actuator.
